(19) United States
(12) Patent Application Publication
(10) Pub. No.: US 2025/0048192 A1
(43) Pub. Date: Feb. 6, 2025

(54) VOICE-SERVICE PROVISIONING FOR INTER-OPERATOR ROAMING

(71) Applicant: Apple Inc., Cupertino, CA (US)

(72) Inventors: Fangli Xu, Beijing (CN); Xiaoyu Qiao, Beijing (CN); Dawei Zhang, Saratoga, CA (US); Huarui Liang, Beijing (CN); Haijing Hu, Los Gatos, CA (US); Shu Guo, Beijing (CN); Fang Li, Beijing (CN); Lanpeng Chen, Beijing (CN)

(73) Assignee: Apple Inc., Cupertino, CA (US)

(21) Appl. No.: 18/263,128

(22) PCT Filed: Jul. 28, 2022
(86) PCT No.: PCT/CN2022/108654

§ 371 Date: Jul. 26, 2023

(51) Int. Cl. H04W 36/00; H04W 84/04

(52) U.S. Cl. CPC H04W 36/00226; H04W 36/00222; H04W 84/042

(57) ABSTRACT

The present application relates to devices and components including apparatus, systems, and methods for supporting voice services during roaming.

### BACKGROUND

Third Generation Partnership Project (3GPP) Technical Specifications (TSs) define standards for wireless networks. These TSs describe aspects related to providing voice services through various radio access technologies.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates an operational flow/algorithmic structure in accordance with some embodiments.

FIG. 4 illustrates another operational flow/algorithmic structure in accordance with some embodiments.

FIG. 5 illustrates another operational flow/algorithmic structure in accordance with some embodiments.

FIG. 6 illustrates another operational flow/algorithmic structure in accordance with some embodiments.

FIG. 7 illustrates a user equipment in accordance with some embodiments.

FIG. 8 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

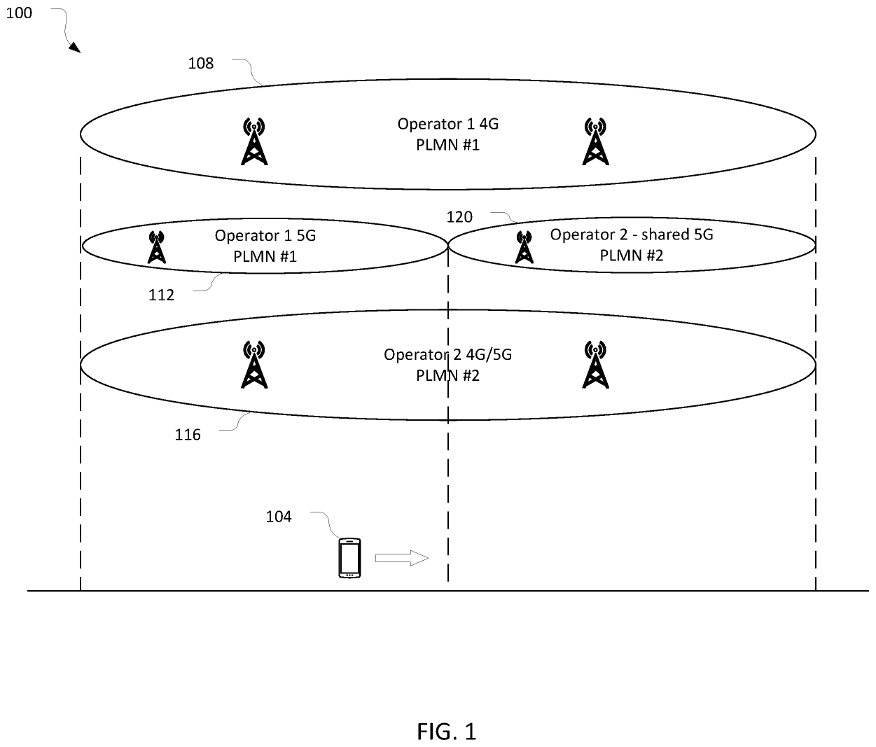

FIG. 1 illustrates a network environment 100 in accordance with some embodiments. The network environment 100 may include a user equipment 104 and base stations provided by various operators. The operators may have base stations that provide cell coverage according to a 3GPP Long Term Evolution (LTE) radio access technology (RAT), which may also be referred to as 4^{th} Generation (4G) coverage, and may have base stations that provide cell coverage according to a 3GPP New Radio (NR) RAT, which may also be referred to as 5^{th} Generation (5G) coverage. In general, the base stations that provide 4G coverage may be referred to as evolved node Bs (eNBs) and the base stations that provide 5G coverage may be referred to as next-generation node Bs (gNBs).

The UE 104 may be a subscriber of operator 1 and may be connected with a serving cell provided by a base station of operator 1's public land mobile network (PLMN) #1, which may be referred to as a home public land mobile network (HPLMN) of the UE 104. The operator 1 may provide a 4G coverage area 108 and a 5G coverage area 112. The 5G coverage area 112 may only be provided for part of the 4G coverage area 108.

An operator 2 may have a PLMN #2 that includes a full 4G/5G coverage area 116. Operator 1 and operator 2 may have a roaming agreement in which operator 2 provides a shared 5G coverage area 120 for UEs having a subscription with operator 1. The shared 5G coverage area may correspond to the area in which operator 1 only provides 4G coverage.

The national roaming agreements in 5G may be flexible and, in some scenarios, may restrict services to an inbound roaming terminal. For example, when PLMN #2 is operating as an equivalent PLMN (EPLMN) with respect to PLMN #1, it may only provide the UE 104 support for 5G RAT. Thus, the PLMN #2 would provide voice over NR (VoNR) for a voice call of the UE 104 in the shared 5G coverage area 120.

A 5G network provides voice over Internet Protocol multimedia subsystem (VoIMS) over packet switched (PS) services in two methods: VoNR and evolved packet system (EPS) fallback, in which the voice call falls back to a voice over LTE (VOLTE). However, for EPS fallback, a network transitions from a 5G service to a 4G/3G service provided by the same operator. This may cause an issue in which a voice call cannot be guaranteed after roaming to an EPLMN (for example, PLMN #2). Further, when roaming to the PLMN #2, the UE 104 may only know whether the PLMN #2 supports VoIMS voice over PS, but may not know the details about which scheme is provided (e.g., VoNR only, EPS fallback only, both VoNR and EPS fallback, intra-operator EPS fallback, or inter-operator EPS fallback). It may be noted that the network can indicate VoIMS over PS if UE supports both VoNR and EPS fallback features. If the UE 104 does not support VoNR and camps on the operator 2 shared 5G coverage area 120, but operator 2 cannot provide the voice service to the UE 104, a voice call may be interrupted.

Embodiments of the present disclosure provide for the setting of an IMS voice over PS session supported indication in a manner that enables a UE to fallback to its HPLMN in the event compatibility issues may exist with respect to an EPLMN that provides limited 5G roaming services. Additional embodiments describe support for inter-operator EPS fallback to enable redirection to the HPLMN.

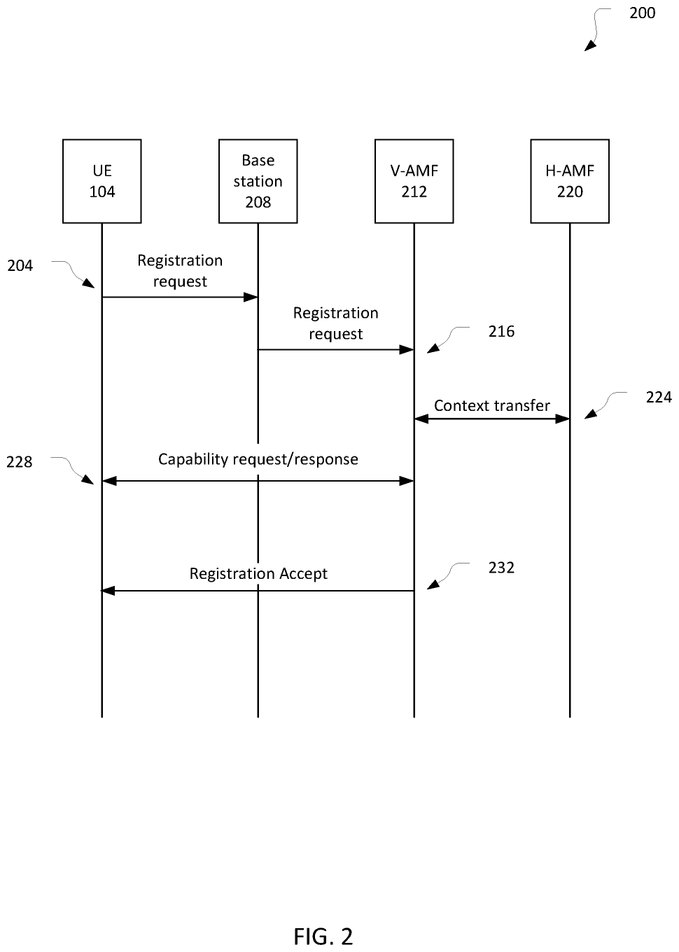

FIG. 2 illustrates a signal diagram 200 of a non-access stratum (NAS) registration procedure in a roaming scenario in accordance with some embodiments. In this embodiment, the UE 104 may be roaming to the shared 5G coverage area 120 discussed in FIG. 1. Except as otherwise described herein, the NAS registration procedure depicted by signaling diagram 200 may be similar to that described in clause 4.2.2.2.2 of 3GPP TS 23.502 v17.5.0 (2022 June).

At 204, the UE 104 may transmit a registration request to a base station 208 of a radio access network (RAN) of the PLMN #2 provided by operator 2.

The base station 208 may select a visiting-access and mobility management function (V-AMF) 212 of a 5G core network (5GC) to which a registration request may be sent at 216. The V-AMF 212 may be located in a roaming network, for example, the PLMN #2 provided by operator 2 as described above.

The V-AMF 212 may conduct a context transfer with a home-AMF (H-AMF) 220 within PLMN #1. As part of the context transfer, the H-AMF 220 may provide the V-AMF 212 with a context of the UE 104.

The V-AMF 212 may obtain various capabilities of the UE 104 from the UE context or within the registration request. If further information is needed, for example, additional capability information with respect to VoNR support, the V-AMF 212 may connect with the UE 104 through the RAN to fetch the UE capability in a capability request/response at 228. The UE 104 may report its VoNR capability via an AS capability reporting procedure.

The V-AMF 212 may engage with a number of other entities in the 5G system (5GS) (not explicitly shown) to determine whether the 5GS can provide service to the UE 104. If the PLMN #2 is capable of providing service to the UE 104, the V-AMF 212 may transmit a registration accept message to the UE 104 at 232.

The registration accept message may include a 5GS network feature support information element (IE) to inform the UE 104 of the support of certain features. The 5GS network feature support IE may include an indication of whether IMS voice over PS session is supported in 3GPP access or whether the operator supports EPS fallback to LTE. The V-AMF 212 may set the IMS VoPS session supported (IVSS) indication according to voice capabilities of the UE 104 (for example, whether the UE 104 supports VoNR) and voice service features that the EPLMN may provide to a roaming UE. In some embodiments, the IVSS indication may be set according to one of the three cases shown in Table 1 below.

TABLE 1

| | Roaming UE's | Detailed feature for voice service | IVSS |
|---|---|---|---|
| Case | capability | provided to roaming UE by EPLMN | indication |
| 1 | No support of VoNR | Only provide VoNR for the voice | No indication |
| | | service | |
| 2 | Support of VoNR | Only provide VoNR for the voice | Indication |
| | | service | |
| 3 | No support of VoNR | Provide inter-operator EPS fallback for | Indication |
| | | roaming UE | |

In case 1, the roaming UE does not support VoNR and the roaming network only provides VoNR for the voice service. In this case, the V-AMF 212 may configure the registration accept message in a manner to cause the provide no IVSS indication in the 5GS network feature support IE (for example, the IVSS indication bit may not be set). The UE 104, upon receiving the registration accept message without the IVSS indication, may determine that the EPLMN, for example, PLMN #2, is not able to provide IMS voice service to the UE 104 and, therefore, the UE 104 may fall back to its HPLMN, for example, PLMN #1, for 4G voice service.

In case 2, the roaming UE supports VoNR and the roaming network provides VoNR for the voice service. In this case, the V-AMF 212 may provide an IVSS indication in the 5GS network feature support IE. The UE 104, upon receiving the registration accept message with the IVSS indication, may determine that the EPLMN, for example, PLMN #2, is able to provide IMS voice service to the UE 104 and, therefore, the UE 104 may complete the NAS registration procedure to obtain voice service from the EPLMN.

In case 3, the roaming UE does not support VoNR and the roaming network provides inter-operator EPS fallback for the roaming UE. In this case, the V-AMF 212 may provide an IVSS indication in the 5GS network feature support IE. The IVSS indication may indicate that the operator supports VoNR and can trigger the EPS fallback to the HPLMN in order to support the roaming UE's voice service. The UE 104, upon receiving the registration accept message with the IVSS indication, may determine that the EPLMN, for example, PLMN #2, is able to provide IMS voice service. However, since the UE 104 does not support VoNR, the UE 104 may fall back to its HPLMN, for example, PLMN #1, for 4G voice service. This may be referred to as inter-operator EPS fallback.

Some embodiments may provide aspects related to inter-operator EPS fallback. Some of these aspects may be combinable with the inter-operator EPS fallback discussed above with respect to case 3.

In some embodiments, the 5GS EPLMN may provide information to the UE 104 that causes the UE 104 to fall back to its HPLMN. This information, which may be referred to as HPLMN redirection information, may be provided through a radio resource control (RRC) release message that is transmitted after the roaming UE 104 establishes an RRC connection with the EPLMN. The base station in the visiting network may determine that the UE is roaming and acquire the relevant HPLMN redirection information from roaming information provided by a core network/AMF.

The RRC release message may include the HPLMN redirection information in a redirected carrier information (redirectedCarrierInfo) IE or a voice fallback indication (voiceFallbackIndication) IE. The redirectedCarrierInfo IE may be used to provide a detailed carrier list for redirection to a EUTRA network. The list may include one or more redirectedCarrierInfo-EUTRA IEs that each provide frequency information (for example, an absolute radio-frequency channel number (ARFCN)) for a carrier of an EUTRA network. The voiceFallbackIndication IE, when set to true, may inform a UE that the release is for voice fallback purposes. Thus, when the UE initiates a connection in a new cell, the UE can use voice call as the UE connection establishment cause.

In some embodiments, the HPLMN redirection information may be in the redirectedCarrierInfo IE. For example, the abstract syntax notation 1 (ASN.1) code for this embodiment may be as follows:

| | |
|---|---|
| RedirectedCarrierInfo ::= | CHOICE { |
| NR | CarrierInfoNR, |
| eutra | RedirectedCarrierInfo-EUTRA |
| HPLMN | RedirectedCarrierInfo-EUTRA |
| ... | |
| }. | |

In this instance, if frequency information is provided in the eutra IE, it may correspond to an EUTRA provided by the same operator and correspond to an intra-operator EPS fallback. However, if the frequency information is provided in the HPLMN IE, it may correspond to an EUTRA provided by the home operator and correspond to an inter-operator EPS fall back.

The redirectedCarrierInfo IE may include a HPLMN redirection parameter that provides an HPLMN redirection indication. This may be as simple as a one-bit indication. However, additional bits may also be used to convey additional information.

The ASN.1 code for providing the HPLMN redirection indication in the redirectedCarrierInfo IE may be as follows:

| | |
|---|---|
| RedirectedCarrierInfo ::= | CHOICE { |
| nr | CarrierInfoNR, |
| eutra | RedirectedCarrierInfo-EUTRA, |
| inter-operator-indication | ENUMERATED {true}, |
| OPTIONAL, --Need N | |
| ... | |
| }. | |

In some embodiments, the inter-operator-indication may be a single-bit set to ‘1’ to indicate that the associated frequency information (RedirectedCarrierInfo-EUTRA) is for a carrier frequency in the HPLMN and set to ‘0’ to indicate that the associated frequency information (RedirectedCarrierInfo-EUTRA) is for a carrier frequency in the EPLMN.

In some embodiments, the HPLMN redirection information may be embedded in the redirectedCarrierInfo-EUTRA IE itself. If the HPLMN redirection information is in the redirectedCarrierInfo-EUTRA IE, it may be provided by one or more of the following options.

In a first option, the redirectedCarrierInfo-EUTRA IE may have no frequency information. Given that a redirectedCarrierInfo-EUTRA IE is expected to provide frequency information for the carrier to which the UE 104 is redirected, the UE 104 may interpret the omitted frequency information as the HPLMN redirection information that instructs the UE 104 is to fall back to its HPLMN for voice services.

The ASN.1 code for this option may be as follows:

| | |
|---|---|
| RedirectedCarrierInfo ::= | CHOICE { |
| NR | CarrierInfoNR, |
| eutra | RedirectedCarrierInfo-EUTRA |
| eutra-01 | RedirectedCarrierInfo-EUTRA-01 |

...
}
...............................................

| RedirectedCarrierInfo-EUTRA ::= | SEQUENCE { | |
|---|---|---|
| eutraFrequency | ARFCN-ValueEUTRA, | |
| cnType | ENUMERATED {epc, fiveGC} | OPTIONAL -- |

Need N
}

| RedirectedCarrierInfo-EUTRA-01 ::= SEQUENCE { | | |
|---|---|---|
| eutraFrequency | ARFCN-ValueEUTRA | OPTIONAL -- |

Need N

| | | |
|---|---|---|
| cnType | ENUMERATED {epc, fiveGC} | OPTIONAL -- |

Need N
}

In this option, the frequency list (for example, eutraFrequency fields) is made optional to allow for its omission.

In a second option, the redirectedCarrierInfo-EUTRA IE may include frequency information for a 4G carrier provided by its HPLMN (for example, PLMN #1 provided by operator 1). With this option, the UE 104 may be capable of determining an association between given frequency information and the HPLMN carrier. The UE 104 may be configured with this association by the HPLMN or the VPLMN. The UE 104 may follow a legacy behavior and switch to the indicated operator 1 4G frequency for cell search and may camp there for voice services.

The ASN.1 code for this option may be as follows:

| | |
|---|---|
| RedirectedCarrierInfo ::= | CHOICE { |
| nr | CarrierInfoNR, |
| eutra | RedirectedCarrierInfo-EUTRA, |

...
}.

In the second option, it will be understood that the network provides inter-operator information in the RedirectedCarrierInfo-EUTRA IE.

In a third option, the redirectedCarrierInfo-EUTRA IE may include a new HPLMN 4G frequency list for inter-operator fallback. Similar to option 2, the UE 104 may understand that the frequency information of the frequency list is associated with its HPLMN. Thus, the UE 104 may determine that it is to fall back to its HPLMN and select one of the 4G carriers from the list for voice services.

The ASN.1 code for this option may be as follows:

| | |
|---|---|
| RedirectedCarrierInfo ::= | CHOICE { |
| nr | CarrierInfoNR, |
| eutra | RedirectedCarrierInfo-EUTRA, |
| eutra-interoperator | RedirectedCarrierInfo-EUTRA, |

...
}........................................

| RedirectedCarrierInfo-EUTRA ::= | SEQUENCE { | |
|---|---|---|
| eutraFrequency | ARFCN-ValueEUTRA, | |
| cnType | ENUMERATED {epc,fiveGC} | OPTIONAL |

-- Need N
}.

In this option, the eutra-interoperator field may support one or more carrier frequencies (RedirectedCarrierInfo-EUTRA) for the inter-operator case.

In a fourth option, the redirectedCarrierInfo-EUTRA IE of the second or third options may be used in conjunction with the inter-operator indication in the redirectedCarrierInfo IE discussed above. For example, the UE 104 may not be aware of the mapping between the frequency information in the HPLMN. However, given the presence of the inter-operator indication in the redirectedCarrierInfo IE, the UE 104 may understand that the given frequency information is associated with the HPLMN.

The ASN.1 code for this option may be as follows:

| RedirectedCarrierInfo ::= | CHOICE { | |
|---|---|---|
| nr | CarrierInfoNR, | |
| eutra | RedirectedCarrierInfo-EUTRA, | |
| inter-operator-indication | ENUMERATED {true}, | OPTIONAL, --Need N |

...
}........................................

| RedirectedCarrierInfo-EUTRA ::= | SEQUENCE { | |
|---|---|---|
| eutraFrequency | ARFCN-ValueEUTRA, | |
| cnType | ENUMERATED {epc,fiveGC} | OPTIONAL |

-- Need N
}.

In this option, the UE 104 may understand, based on the one-bit inter-operator indication, whether the inter-operator information is included in the frequency list.

For the first and third options (and use of the inter-operator indication in the RedirectedCarrierInfo IE), if the current cell is a roaming cell, the UE 104 may fall back to its HPLMN 4G frequency for cell search and camping.

Two options may be used in the embodiments in which the HPLMN redirection information is included in the voiceFallbackIndication IE in the RRCRelease message.

In the first option, if the EPLMN can support the inter-operator EPS fallback, its base station may use an existing indication to indicate that the UE 104 is to fall back to the HPLMN.

In the second option, a new indication may be introduced to indicate the voiceFallbackIndication to HPLMN in the RRC release message. The ASN.1 code for this option may be as follows:

| RRCRelease IEs ::= | SEQUENCE { | |
|---|---|---|
| voiceFallbackIndication | ENUMERATED {true} | OPTIONAL, -- |

Need N

| | | |
|---|---|---|
| voiceFallbackIndication-inter-operator | ENUMERATED {true} | OPTIONAL, -- |

Need N

| | |
|---|---|
| measIdleConfig | SetupRelease {MeasIdleConfigDedicated} |

OPTIONAL, -- Need N

| | | |
|---|---|---|
| nonCriticalExtension | RRCRelease-IEs | OPTIONAL |

}.

In the above ASN.1 code, the new indication may be provided by the voiceFallbackIndication-inter-operator IE.

With either option, the UE 104, upon receiving the voiceFallbackIndication, may fall back to its HPLMN 4G frequency for cell search and camping.

In some embodiments, the UE 104 may acquire the network feature with respect to voice-service support via RAN signaling while roaming. The visited network may provide the UE 104 with the voice-service support information via dedicated signaling (for example, RRC signaling) or broadcast signaling (for example, a system information block (SIB) message). In some embodiments, the voice-service support information may indicate whether the visited network supports VoNR or inter-operator EPS fallback. If the visited network supports inter-operator EPS fallback, the voice-service support information may additionally provide relevant fallback-related information in some instances.

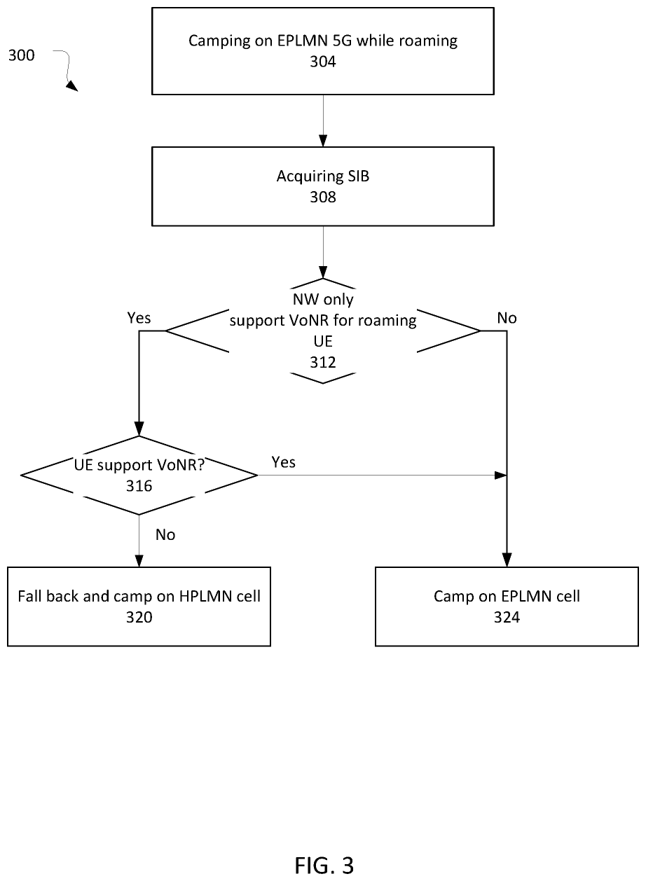

FIG. 3 is an operation flow/algorithmic structure 300 in accordance with some embodiments. The operation flow/algorithmic structure 300 may be performed by a UE such as UE 104, UE 700; or components thereof, for example, processors 704.

The operation flow/algorithmic structure 300 may include, at 304, camping on a 5G EPLMN while roaming. The UE may be roaming from an HPLMN that provides full 4G coverage and only partial 5G coverage as shown in FIG. 1, for example.

The operation flow/algorithmic structure 300 may further include, at 308, acquiring a system information block (SIB) that has voice-service support information. The UE may acquire the SIB in a manner consistent with an initial cell search procedure. For example, the UE may first obtain a master information block (MIB) after detecting a synchronization signal and physical broadcast channel block (SSB) transmitted by a base station of the EPLMN. The UE may determine the control resource set (CORESET) and search space of a physical downlink control channel (PDCCH) that allocates resources for a SIB 1 (SIB1) transmission, which may provide scheduling information for other SIBs. The voice-service support information may be in the SIB1 transmission itself or one of the other SIBs.

The ASN.1 code for an embodiment in which the voice-service support information is included in a SIB1 may be as follows:

SIB1 ::= SEQUENCE {

| | |
|---|---|
| cellSelectionInfo | SEQUENCE { |

...

| cellAccessRelatedInfo | CellAccessRelatedInfo, | |
|---|---|---|
| connEstFailureControl | ConnEstFailureControl | OPTIONAL, -- Need R |
| si-SchedulingInfo | SI-SchedulingInfo | OPTIONAL, -- Need R |
| servingCellConfigCommon | ServingCellConfigCommonSIB | OPTIONAL, -- |

Need R

| | | |
|---|---|---|
| ims-EmergencySupport | ENUMERATED {true} | OPTIONAL, -- Need R |
| eCallOverIMS-Support | ENUMERATED {true} | OPTIONAL, -- Cond |

Absent

| | | |
|---|---|---|
| ue-TimersAndConstants | UE-TimersAndConstants | OPTIONAL, -- Need R |

| | |
|---|---|
| uac-BarringInfo | SEQUENCE { |

...

| | | |
|---|---|---|
| useFullResumeID | ENUMERATED {true} | OPTIONAL, -- Need N |
| lateNonCriticalExtension | OCTET STRING | OPTIONAL, |
| voNR-Support | ENUMERATED {true} | OPTIONAL, --Need N |
| ePSFallback-Interoperator-support | ENUMERATED {true} | OPTIONAL, --Need N |
| nonCriticalExtension | SEQUENCE{ } | OPTIONAL |

}

Thus, the SIB1 transmission may provide an indication of whether the EPLMN supports VoNR or inter-operator EPS fallback.

In some embodiments, the voNR-Support parameter may be labeled in other manners. For example, the parameter may be labeled as only VoNR-supportForRoamingUE to indicate that the RAN only supports VoNR for voice services for a roaming UE.

The operation flow/algorithmic structure 300 may further include, at 312, determining whether the network only supports VoNR as the voice service for the roaming UE. This determination may be based on the voice-service support information in the SIB.

If it is determined, at 312, that the network only supports VoNR as the voice service for the roaming UE, the operation flow/algorithmic structure 300 may advance to determining whether the UE supports VoNR at 316.

If it is determined, at 316, that the UE does not support VoNR, the operation flow/algorithmic structure 300 may advance to performing an inter-operator fallback and the UE may camp on its HPLMN cell. In this case, the UE may understand that the EPLMN will not be able to provide 5G voice services to the UE. Thus, the UE will camp on its HPLMN cell where it may receive 4G voice services.

If it is determined, at 312, the network does not only support VoNR as the voice service for the roaming UE or it is determined, at 316, the UE supports VoNR, the operation flow/algorithmic structure 300 may advance to camping on the EPLMN cell for 5G voice service. In this case, the UE will understand that the EPLMN can provide 5G voice services and this differentiated level of service may justify use of the visited network.

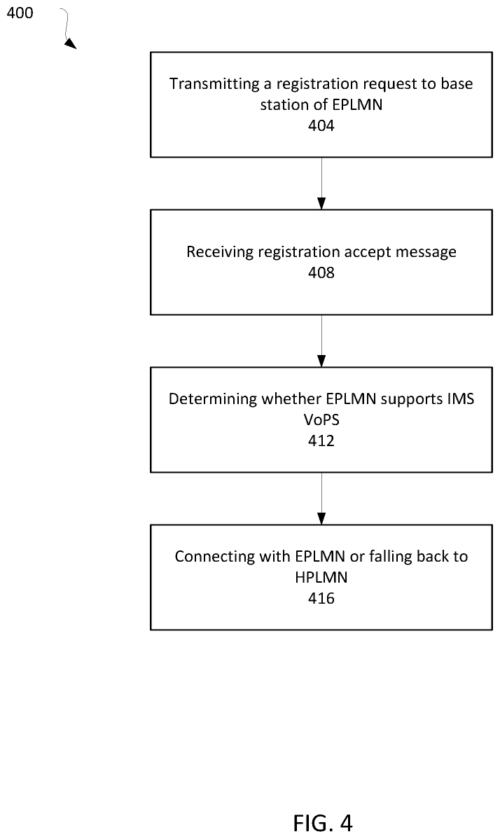

FIG. 4 includes an operation flow/algorithmic structure 400 in accordance with some embodiments. The operation flow/algorithmic structure 400 may be performed or implemented by a UE such as, for example, UE 104 or UE 700; or components thereof, for example, processors 704.

The operation flow/algorithmic structure 400 may include, at 404, transmitting a registration request to a base station of an EPLMN. The registration request may be part of a NAS registration procedure as described elsewhere herein.

The operation flow/algorithmic structure 400 may further include, at 408, receiving a registration accept message. The registration accept message may include a 5GS network feature support IE. The network feature support IE may be generated by a V-AMF of the EPLMN based on UE capabilities and voice services provided to roaming UEs by the EPLMN.

The operation flow/algorithmic structure 400 may further include, at 412, determining whether the network feature support IE includes an IVSS indication.

The operation flow/algorithmic structure 400 may further include, at 416, connecting with the EPLMN or falling back to the HPLMN based on whether the network feature support IE includes the IVSS indication and a capability of the UE. For example, if the network support feature IE does not include the IVSS indication, the UE may fall back to the HPLMN for voice services. The UE may also fall back to the HPLMN for voice services if the network support feature IE includes the IVSS indication, but the UE does not support VoNR. If the network support feature IE includes the IVSS indication and the UE supports VoNR, the UE may connect with the EPLMN for voice services.

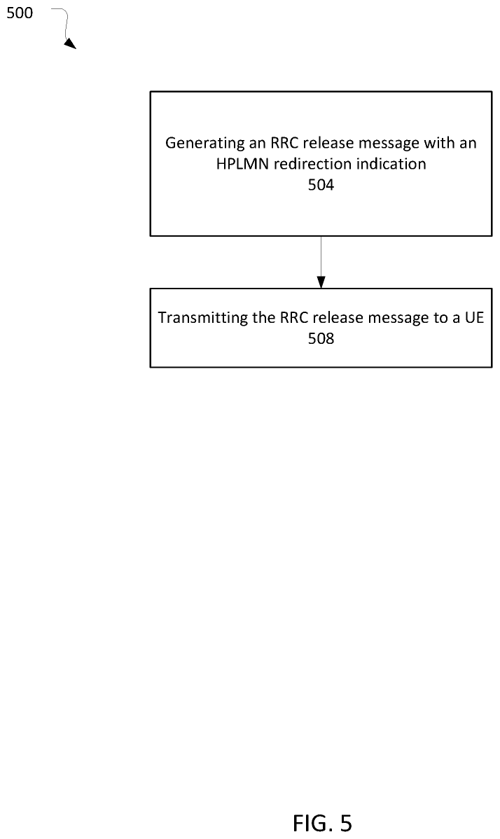

FIG. 5 includes an operation flow/algorithmic structure 500 in accordance with some embodiments. The operation flow/algorithmic structure 500 may be performed or implemented by a base station such as, for example, a base station of FIG. 1, base station 208, or network node 800; or components thereof, for example, processors 804.

The operation flow/algorithmic structure 500 may include, at 504, generating an RRC release message with an HPLMN redirection indication. The RRC release message may be generated after a roaming UE has established a connection with an EPLMN.

The HPLMN redirection information may be information that instructs the UE to fall back to an HPLMN for voice services. This information may be explicit (by providing an inter-operator indication in a redirection element or providing a frequency value that is known by the UE to be associated with the HPLMN). Alternatively, this information may be implicit, for example, a lack of any frequency values in a RedirectedCarrierInfo-EUTRA IE, which the UE may interpret as the HPLMN redirection indication.

The operation flow/algorithmic structure 500 may further include, at 508, transmitting the RRC release message to a UE.

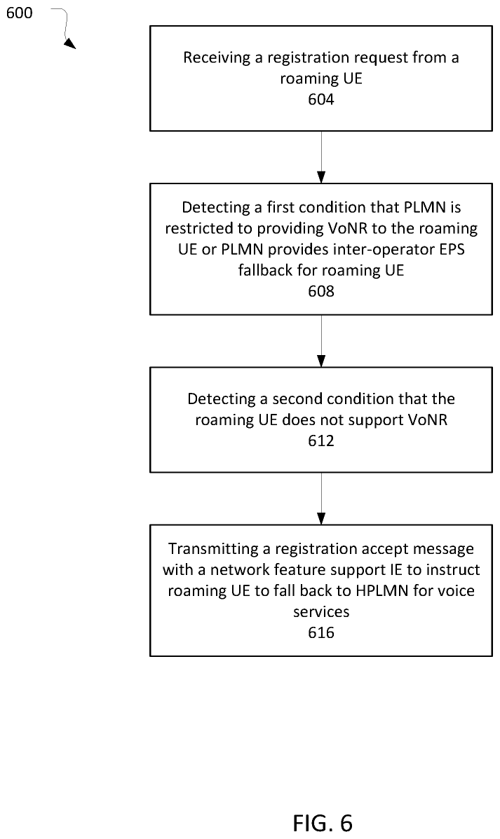

FIG. 6 includes an operation flow/algorithmic structure 600 in accordance with some embodiments. The operation flow/algorithmic structure 600 may be performed or implemented by an AMF such as, for example, V-AMF 212 or network node 800; or components thereof, for example, processors 804.

The operation flow/algorithmic structure 600 may include, at 604, receiving a registration request from a roaming UE. The registration request may be received via a base station of the EPLMN.

The operation flow/algorithmic structure 600 may further include, at 608, detecting a first condition. In some embodiments, the first condition may be that the voice services provided by the EPLMN to the roaming UE are restricted to VoNR. In some embodiments, the first condition may additionally/alternatively be that the EPLMN provides inter-operator EPS fallback for the roaming UE.

The operation flow/algorithmic structure 600 may further include, at 612, detecting a second condition. In some embodiments, the second condition may be that the roaming UE does not support VoNR. This condition may be detected based on UE capability information provided from a HPLMN node or from the UE itself.

The operation flow/algorithmic structure 600 may further include, at 616, transmitting a registration accept message to the roaming UE. The registration accept message may include a network feature support IE to instruct the roaming UE to fall back to HPLMN for voice services. This instruction may be provided to the roaming UE based on detection of the first and second conditions. In some embodiments, this instruction may be accomplished by generating the network feature support IE with or without an IVSS indication.

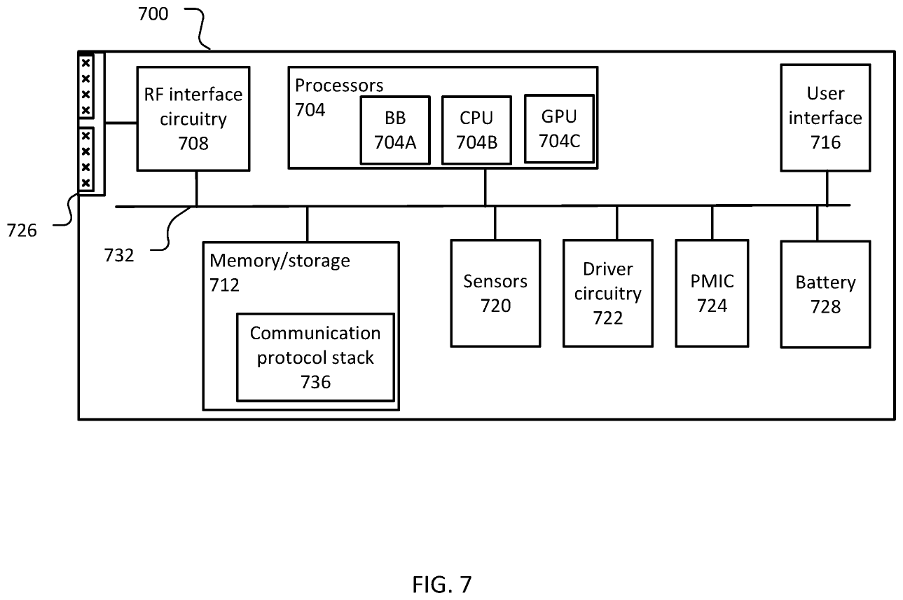

FIG. 7 illustrates an example UE 700 in accordance with some embodiments. The UE 700 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 700 may include processors 704, RF interface circuitry 708, memory/storage 712, user interface 716, sensors 720, driver circuitry 722, power management integrated circuit (PMIC) 724, antenna structure 726, and battery 728. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 732, which may represent any type of interface, input/output, bus (local, system, or expansion), transmission line, trace, optical connection, etc. that allows various circuit components (on common or different chips or chipsets) to interact with one another.

The processors 704 may include processor circuitry such as, for example, baseband processor circuitry (BB) 704A, central processor unit circuitry (CPU) 704B, and graphics processor unit circuitry (GPU) 704C. The processors 704 may include any type of circuitry or processor circuitry that executes or otherwise operates computer-executable instructions, such as program code, software modules, or functional processes from memory/storage 712 to cause the UE 700 to perform operations as described herein.

In some embodiments, the baseband processor circuitry 704A may access a communication protocol stack 736 in the memory/storage 712 to communicate over a 3GPP compatible network. In general, the baseband processor circuitry 704A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 708.

The baseband processor circuitry 704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 712 may include one or more non-transitory, computer-readable media that includes instructions (for example, communication protocol stack 736) that may be executed by one or more of the processors 704 to cause the UE 700 to perform various operations described herein. The memory/storage 712 include any type of volatile or non-volatile memory that may be distributed throughout the UE 700. In some embodiments, some of the memory/storage 712 may be located on the processors 704 themselves (for example, L1 and L2 cache), while other memory/storage 712 is external to the processors 704 but accessible thereto via a memory interface. The memory/storage 712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 708 may include transceiver circuitry and radio frequency front module (RFEM) that allows the UE 700 to communicate with other devices over a radio access network. The RF interface circuitry 708 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 726 and proceed to filter and amplify (with a low-noise amplifier) the signal. The signal may be provided to a receiver of the transceiver that down-converts the RF signal into a baseband signal that is provided to the baseband processor of the processors 704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 726.

In various embodiments, the RF interface circuitry 708 may be configured to transmit/receive signals in a manner compatible with NR access technologies.

The antenna 726 may include antenna elements to convert electrical signals into radio waves to travel through the air and to convert received radio waves into electrical signals. The antenna elements may be arranged into one or more antenna panels. The antenna 726 may have antenna panels that are omnidirectional, directional, or a combination thereof to enable beamforming and multiple-input, multiple-output communications. The antenna 726 may include microstrip antennas, printed antennas fabricated on the surface of one or more printed circuit boards, patch antennas, phased array antennas, etc. The antenna 726 may have one or more panels designed for specific frequency bands including bands in FR1 or FR2.

In some embodiments, the UE 700 may include the beamforming circuitry 700 (FIG. 7), where the beamforming circuitry 700 may be utilized for communication with the UE 700. In some embodiments, components of the UE 700 and the beamforming circuitry may be shared. For example, the antennas 726 of the UE may include the panel 1 704 and the panel 2 708 of the beamforming circuitry 700.

The user interface circuitry 716 includes various input/output (I/O) devices designed to enable user interaction with the UE 700. The user interface 716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 700.

The sensors 720 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 722 may include software and hardware elements that operate to control particular devices that are embedded in the UE 700, attached to the UE 700, or otherwise communicatively coupled with the UE 700. The driver circuitry 722 may include individual drivers allowing other components to interact with or control various input/output (I/O) devices that may be present within, or connected to, the UE 700. For example, driver circuitry 722 may include a display driver to control and allow access to a display device, a touchscreen driver to control and allow access to a touchscreen interface, sensor drivers to obtain sensor readings of sensor circuitry 720 and control and allow access to sensor circuitry 720, drivers to obtain actuator positions of electro-mechanic components or control and allow access to the electro-mechanic components, a camera driver to control and allow access to an embedded image capture device, audio drivers to control and allow access to one or more audio devices.

The PMIC 724 may manage power provided to various components of the UE 700. In particular, with respect to the processors 704, the PMIC 724 may control power-source selection, voltage scaling, battery charging, or DC-to-DC conversion.

In some embodiments, the PMIC 724 may control, or otherwise be part of, various power saving mechanisms of the UE 700. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 700 may power down for brief intervals of time and thus save power. If there is no data traffic activity for an extended period of time, then the UE 700 may transition off to an RRC_Idle state, where it disconnects from the network and does not perform operations such as channel quality feedback, handover, etc. The UE 700 goes into a very low power state and it performs paging where again it periodically wakes up to listen to the network and then powers down again. The UE 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 728 may power the UE 700, although in some examples the UE 700 may be mounted deployed in a fixed location, and may have a power supply coupled to an electrical grid. The battery 728 may be a lithium ion battery, a metal-air battery, such as a zinc-air battery, an aluminum-air battery, a lithium-air battery, and the like. In some implementations, such as in vehicle-based applications, the battery 728 may be a typical lead-acid automotive battery.

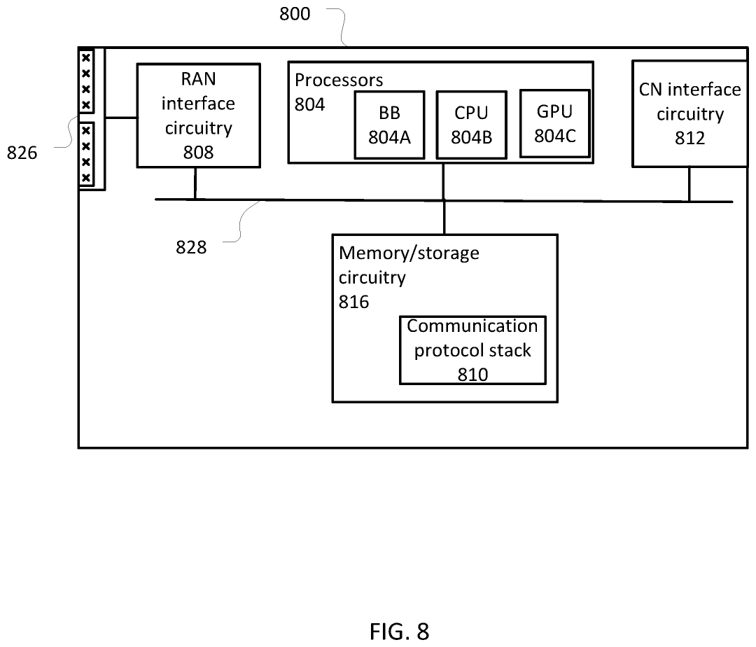

FIG. 8 illustrates an example network node 800 in accordance with some embodiments. The network node 800 may be a base station or an AMF as describe elsewhere herein. The network node 800 may include processors 804, RF interface circuitry 808, core network (CN) interface circuitry 812, memory/storage circuitry 816, and antenna structure 826. The RF interface circuitry 808 and antenna structure 826 may not be included when the network node 800 is an AMF.

The components of the network node 800 may be coupled with various other components over one or more interconnects 828.

The processors 804, RF interface circuitry 808, memory/storage circuitry 816 (including communication protocol stack 810), antenna structure 826, and interconnects 828 may be similar to like-named elements shown and described with respect to FIG. 7.

The CN interface circuitry 812 may provide connectivity to a core network, for example, a 5th Generation Core network (5GC) using a 5GC-compatible network interface protocol such as carrier Ethernet protocols, or some other suitable protocol. Network connectivity may be provided to/from the network node 800 via a fiber optic or wireless backhaul. The CN interface circuitry 812 may include one or more dedicated processors or FPGAs to communicate using one or more of the aforementioned protocols. In some implementations, the CN interface circuitry 812 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method of operating a user equipment (UE), the method comprising: receiving, from a base station of an equivalent public land mobile network (EPLMN), a radio resource control (RRC) release message to include home public land mobile network (HPLMN) redirection information to instruct the UE to fall back to a HPLMN for voice services; releasing a connection with the EPLMN based on the RRC release message; and initiating a connection with the HPLMN for voice services.

Example 2 includes the method of example 1 or some other example herein, wherein the HPLMN redirection information is in a redirected carrier information (RedirectedCarrierInfo) information element (IE) of the RRC release message.

Example 3 includes the method of example 2 or some other example herein, wherein the RedirectedCarrierInfo IE includes an inter-operator indication to indicate that the UE is to fall back to the HPLMN for voice services.

Example 4 includes a method of example 1 or some other example herein, wherein HPLMN redirection information is in a redirected carrier information—evolved universal terrestrial radio access (RedirectedCarrierInfo-EUTRA) information element (IE) of the RRC release message.

Example 5 includes a method of example 4 some other example herein, wherein the HPLMN redirection information comprises: omission of a frequency value from the RedirectedCarrierInfo-EUTRA IE; or inclusion of a frequency value associated with the HPLMN.

Example 6 includes a method of operating a base station, the method comprising: generating a radio resource control (RRC) release message to include home public land mobile network (HPLMN) redirection information to instruct a user equipment (UE) to fall back to a HPLMN for voice services, wherein the base station is associated with an equivalent public land mobile network (EPLMN) of the HPLMN; and transmitting the RRC release message to the UE.

Example 7 includes a method of example 6 or some other example herein, further comprising: generating the RRC release message with the HPLMN redirection information in a redirected carrier information (RedirectedCarrierInfo) information element (IE).

Example 8 includes a method of example 7 or some other example herein, wherein generating the RRC release message with the HPLMN redirection information comprises: generating the RedirectedCarrierInfo IE to include an inter-operator indication to indicate that the UE is to fall back to the HPLMN for voice services.

Example 9 includes the method of example 6 or some other example herein, further comprising: generating the RRC release message with the HPLMN redirection information in a redirected carrier information—evolved universal terrestrial radio access (RedirectedCarrierInfo-EUTRA) information element (IE).

Example 10 includes the method of example 9 or some other example herein, wherein generating the RRC release message with the HPLMN redirection information comprises: omitting a frequency value from the RedirectedCarrierInfo-EUTRA IE.

Example 11 includes a method of example 9 or some other example herein, wherein generating the RRC release message with the HPLMN redirection information comprises: generating the RedirectedCarrierInfo-EUTRA IE to include a frequency value associated with the HPLMN.

Example 12 includes the method of example 11 or some other example herein, wherein generating the RRC release message with the HPLMN redirection information comprises: generating the RedirectedCarrierInfo-EUTRA IE to include a plurality of frequency values associated with the HPLMN.

Example 13 includes the method of example 11 or some other example herein, wherein generating the RRC release message with the HPLMN redirection information further comprises: generating the RedirectedCarrierInfo IE to include an inter-operator indication to indicate that the frequency value is associated with the HPLMN.

Example 14 includes the method of example 6 or some other example herein, further comprising: generating the RRC release message with the HPLMN redirection information in a voice fallback indication information element (IE).

Example 15 includes a method of operating a UE, the method comprising: receiving, while roaming from the HPLMN, a dedicated or broadcast signal from a base station associated with an equivalent public land mobile network (EPLMN), the dedicated or broadcast signal having an indication to: indicate whether the base station only supports voice over new radio (VoNR) as a voice service for the UE; or indicate whether the base station supports inter-operator fallback to an evolved packet system for voice services; and determining whether to camp on a cell provided by the base station or fall back to a cell of the HPLMN based on the indication.

Example 16 includes the method of example 15 or some other example herein, wherein the indication is to indicate the base station only supports VoNR as the voice service for the UE and the method further comprises: determining whether to camp on the cell provided by the base station or fall back to the cell of the HPLMN based further on a capability of the UE.

Example 17 includes a method of example 15 or some other example herein, wherein the dedicated or broadcast signal comprises a system information block 1 (SIB1) message.

Example 18 includes a method of operating an access and mobility management function (AMF) of a public land mobile network (PLMN), the method comprising: receiving a registration request associated with a roaming user equipment (UE); detecting a first condition that voice services to be provided by the PLMN to the roaming UE are restricted to voice over new radio (VoNR) or the PLMN is to provide inter-operator evolved packet system (EPS) fallback for the roaming UE; detecting a second condition that the roaming UE does not support VoNR; generating, based on detecting the first and second conditions, a network feature support information element (IE) to instruct the roaming UE to fall back to a home public land mobile network (HPLMN) for voice services; and transmitting the registration accept message with the network feature support IE to the roaming UE.

Example 19 includes a method of example 18 or some other example herein, wherein the network feature support IE is generated without an indication that Internet Protocol multimedia subsystem voice over packet switched session is supported by the PLMN.

Example 20 includes the method of example 18 or some other example herein, wherein the network feature support IE is generated with an indication that Internet Protocol multimedia subsystem voice over packet switched session is supported by the PLMN.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more non-transitory computer-readable media having instructions that, when executed by one or more processors, cause a user equipment (UE) to:
receive, from a base station of an equivalent public land mobile network (EPLMN), a radio resource control (RRC) release message to include home public land mobile network (HPLMN) redirection information to instruct the UE to fall back to a HPLMN for voice services;
release a connection with the EPLMN based on the RRC release message; and
initiate a connection with the HPLMN for voice services.

2. The one or more non-transitory computer-readable media of claim 1, wherein the HPLMN redirection information is in a redirected carrier information (RedirectedCarrierInfo) information element (IE) of the RRC release message.

3. The one or more non-transitory computer-readable media of claim 2, wherein the RedirectedCarrierInfo IE includes an inter-operator indication to indicate that the UE is to fall back to the HPLMN for voice services.

4. The one or more non-transitory computer-readable media of claim 1, wherein HPLMN redirection information is in a redirected carrier information—evolved universal terrestrial radio access (RedirectedCarrierInfo-EUTRA) information element (IE) of the RRC release message.

5. The one or more non-transitory computer-readable media of claim 4, wherein the HPLMN redirection information comprises:
omission of a frequency value from the RedirectedCarrierInfo-EUTRA IE; or
inclusion of a frequency value associated with the HPLMN.

6. A method of operating a base station, the method comprising:
generating a radio resource control (RRC) release message to include home public land mobile network (HPLMN) redirection information to instruct a user equipment (UE) to fall back to a HPLMN for voice services, wherein the base station is associated with an equivalent public land mobile network (EPLMN) of the HPLMN; and
transmitting the RRC release message to the UE.

7. The method of claim 6, further comprising:
generating the RRC release message with the HPLMN redirection information in a redirected carrier information (RedirectedCarrierInfo) information element (IE).

8. The method of claim 7, wherein generating the RRC release message with the HPLMN redirection information comprises:
generating the RedirectedCarrierInfo IE to include an inter-operator indication to indicate that the UE is to fall back to the HPLMN for voice services.

9. The method of claim 6, further comprising:
generating the RRC release message with the HPLMN redirection information in a redirected carrier information—evolved universal terrestrial radio access (RedirectedCarrierInfo-EUTRA) information element (IE).

10. The method of claim 9, wherein generating the RRC release message with the HPLMN redirection information comprises:
omitting a frequency value from the RedirectedCarrierInfo-EUTRA IE.

11. The method of claim 9, wherein generating the RRC release message with the HPLMN redirection information comprises:
generating the RedirectedCarrierInfo-EUTRA IE to include a frequency value associated with the HPLMN.

12. The method of claim 11, wherein generating the RRC release message with the HPLMN redirection information comprises:
generating the RedirectedCarrierInfo-EUTRA IE to include a plurality of frequency values associated with the HPLMN.

13. The method of claim 11, wherein generating the RRC release message with the HPLMN redirection information further comprises:
generating a RedirectedCarrierInfo IE to include an inter-operator indication to indicate that the frequency value is associated with the HPLMN.

14. The method of claim 6, further comprising:
generating the RRC release message with the HPLMN redirection information in a voice fallback indication information element (IE).

15. A user equipment (UE) comprising:
memory to store information related to a home public land mobile network (HPLMN); and
processing circuitry, coupled with the memory, the processing circuitry to:
receive, while roaming from the HPLMN, a dedicated or broadcast signal from a base station associated with an equivalent public land mobile network (EPLMN), the dedicated or broadcast signal having an indication to: indicate whether the base station only supports voice over new radio (VoNR) as a voice service for the UE; or indicate whether the base station supports inter-operator fallback to an evolved packet system for voice services; and
determine whether to camp on a cell provided by the base station or fall back to a cell of the HPLMN based on the indication.

16. The UE of claim 15, wherein the indication is to indicate the base station only supports VoNR as the voice service for the UE and the processing circuitry is further to:
determine whether to camp on the cell provided by the base station or fall back to the cell of the HPLMN based further on a capability of the UE.

17. The UE of claim 15, wherein the dedicated or broadcast signal comprises a system information block 1 (SIB1) message.

18. (canceled)

19. (canceled)

20. (canceled)

21. The one or more non-transitory computer-readable media of claim 3, wherein the inter-operator indication includes a first value for a bit to indicate that associated frequency information is for a carrier frequency in the HPLMN or a second value for the bit to indicate that the associated frequency information is for a carrier frequency in the EPLMN.

22. The one or more non-transitory computer-readable media of claim 1, wherein the HPLMN redirection information is received in a voice fallback indication information element (IE) of the RRC release message.

23. The one or more non-transitory computer-readable media of claim 1, wherein the HPLMN redirection information includes a frequency list for inter-operator fallback.
